(19) United States
(12) Patent Application Publication
(10) Pub. No.: US 2006/0075606 A1
(43) Pub. Date: Apr. 13, 2006

(54) Pry bar handle

(76) Inventor: John C. Lawless, Charlemont, MA (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/269,223

(22) Filed: Nov. 8, 2005

Related U.S. Application Data
(63) Continuation of application No. 10/891,816, filed on Jul. 15, 2004.
Application No. 10/891,816 is a division of application No. 10/420,432, filed on Apr. 22, 2003, now Pat. No. 6,772,994.

(51) Int. Cl. B25G 1/10

(52) U.S. Cl. 16/430

(57) ABSTRACT

A pry bar has generally octagonal cross-section handle with a grip portion having four rounded surfaces formed of a soft elastomeric material and four alternating surfaces formed of hard thermoplastic material. The elastomeric material rounded surfaces are formed with pluralities of small orifices. The handle is formed with an inner hard thermoplastic core and molded over outer elastomeric cover. A metal impact cap is fixed secured in the handle proximate end.

### PRIOR RELATED APPLICATIONS

This application is a continuation of Ser. No. 10/891,816, filed Jul. 15, 2004, which is a divisional of application Ser. No. 10/420,432, filed Apr. 22, 2003, now U.S. Pat. No. 6,772,994, granted Aug. 10, 2004, and incorporates the prior related applications in their entirety and claims priority thereto by reference herein.

### FIELD OF THE INVENTION

This invention relates to hand tools and hand tool handles. This invention specifically relates to pry bars and pry bar handles. This invention specifically relates to an ergonomic handle for hand tools particularly a pry bar.

### BACKGROUND AND DISCUSSION OF THE PRIOR ART

In general, pry bars are of all metal construction and are cumbersome to grip and use. Often the user has to grip a polygonal cross-sectional metal bar portion of the pry bar. One such prior art construction is disclosed in U.S. Pat. No. 6,058,809 to Flanz.

A wrecking tool is disclosed in U.S. Patent application Publication No. 2002/0134971 to Christensen. The Christensen tool has an elongate octagonal cross-sectional metal handle or bar stock portion. A non-octagonal handgrip is attached to the octagonal metal bar.

It is generally known to provide a soft elastomeric molded over cover on a molded hard thermoplastic core for improved grip for knives, screwdrivers, and the like bladed tools. Such prior art constructions are disclosed in Sanelli, U.S. Pat. No. 4,712,304; Gakhar, U.S. Pat. No. 5,390,572; Hoepfl, U.S. Pat. No. 5,964,009; and Panaccione, U.S. Pat. No. 5,956,799.

The pry bar art desires an improved handle so as to provide improved grip with ergonomic functionality.

It is therefore a principal object of the present invention to provide an ergonomic handle for hand tool such as a pry bar.

It is another object of the present invention to provide an improved grip hand tool and pry bar handle.

It is still a further object of the present invention to provide an ergonomic pry bar handle that is of practical design and safe and practical in use.

Present applicant is the inventor of the ergonomic pry bar handle disclosed in U.S. Pat. No. 6,471,186, granted Oct. 29, 2002, which patent and the present application are commonly assigned to Mayhew Steel Products, Inc.

### SUMMARY OF THE INVENTION

A pry bar has a handle with a generally octagonal cross-section with eight grip surfaces. Four of the grip surfaces have hard thermoplastic planar surfaces and four alternating grip surfaces have rounded soft thermoplastic material surfaces. The rounded soft thermoplastic material surfaces have a plurality of rows of small orifices. The user grips the alternating surfaces for a secure ergonomic grip in pry bar operations.

### BRIEF DESCRIPTION OF THE DRAWINGS

FIG. 1 is a distal end perspective view of the pry bar having the ergonomic handle of the present invention;

FIG. 2 is a side elevational view of the pry bar of FIG. 1;

FIG. 3 is a sectional view taken along line 3-3 of FIG. 2;

FIG. 4 is a sectional view taken along line 4-4 of FIG. 3;

FIG. 5 is a sectional view taken along line 5-5 of FIG. 3; and

FIG. 6 is a sectional view taken along line 6-6 of FIG. 3.

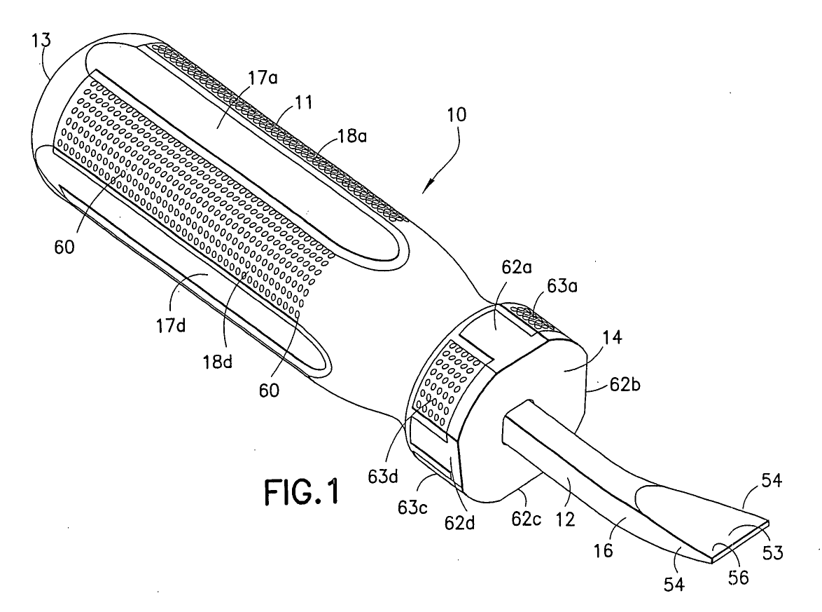

### DESCRIPTION OF THE PREFERRED EMBODIMENT

Referring to FIGS., there is shown pry bar 10 of the present invention. Pry bar 10, in general terms, includes handle 11 and a fixedly attached metal blade or shank 12. Handle 11 has a proximate end 13 and a planar distal end 14. Blade 12 has a proximate end 15 and a distal end 16. Handle 11 is formed of a hard thermoplastic molded core 17 and a molded over integrally bonded elastomeric soft grip cover 18, wherein cover 18 is formed of relatively soft elastomeric material. The proximate end 15 of blade 12 is securely fixedly molded in core 17, with the formation of core 17. The elastomeric cover 18 is then molded over or around specific portions of the core 17, as further discussed hereinafter. Blade 12 is of generally square cross-sectional bar stock construction and has a proximate end 15 and a distal end 16. Proximate end 15 is molded in situ with core 17, so as to be fixedly secured within handle 11, by means well known in the art.

A metal impact cap 50 is fixedly disposed at the distal end of the handle 11. Cap 50 is secured within the handle core 17 by means well known in the screwdriver handle art. Cap 50 is used, by way of example, to impact screw heads prior to driving same. In molding handle core 17 around blade 12 a rectilinear hole 91 is formed in the handle distal end. The proximate end of core 17 is however formed with a circular cylindrical hole 92 for forcibly fixedly holding metal cap 50 in the handle proximate end.

Blade distal end 16 is formed with a pry end 53. Pry end 53 has outwardly tapered sides 54, and upper and lower surfaces 56 and 57. Surfaces 56 and 57 are tapered and extend towards sharpened edge or tip 58. Tip 58 is upwardly angularly disposed with respect to shank 12.

The elastomeric cover 18 does not cover the entire core 17. Four planar thermoplastic surfaces 17a-17d are left uncovered in the grip area of the handle, as best shown in FIG. 5.

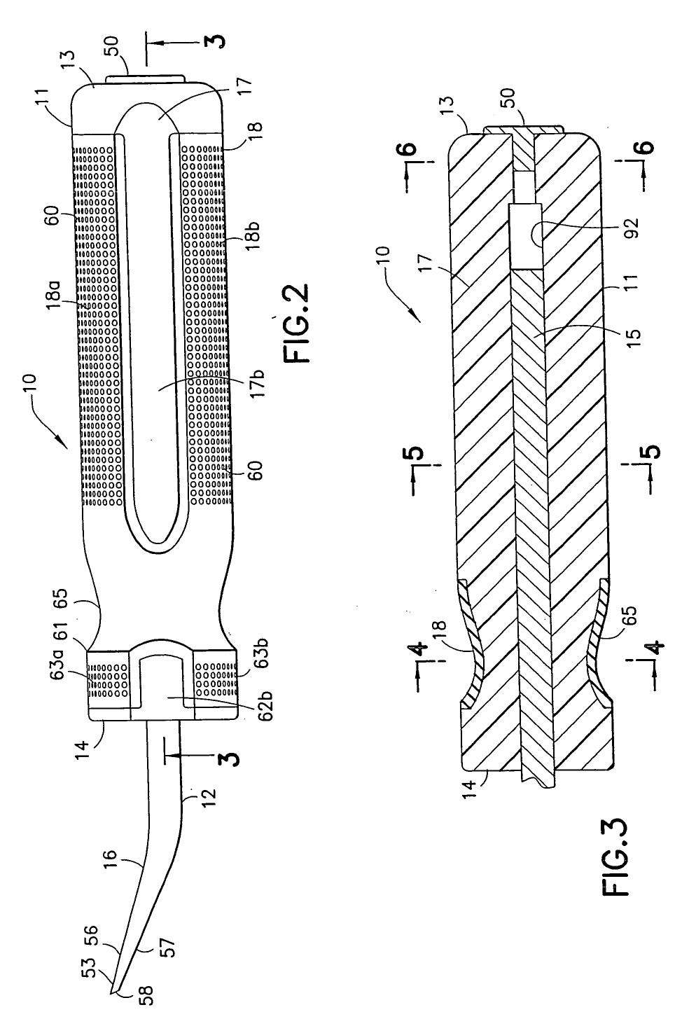

Elastomeric material cover 18 is molded over hard thermoplastic core 17 in the handle grip portion in four curved or rounded grip portions 18a-18d, as best shown in FIGS. 2 and 5. The rounded elastomeric grip portions 18a-18d alternate with the planar hand plastic grip portions 17a-17d. Elastomeric grip portions 18a-18d are formed with a plurality of rows of small crevices or holes 60 (typical). It is believed that the surfaces 17a-17d, 18a-18d in further combination with the small holes provides improved grip and comfort for the user.

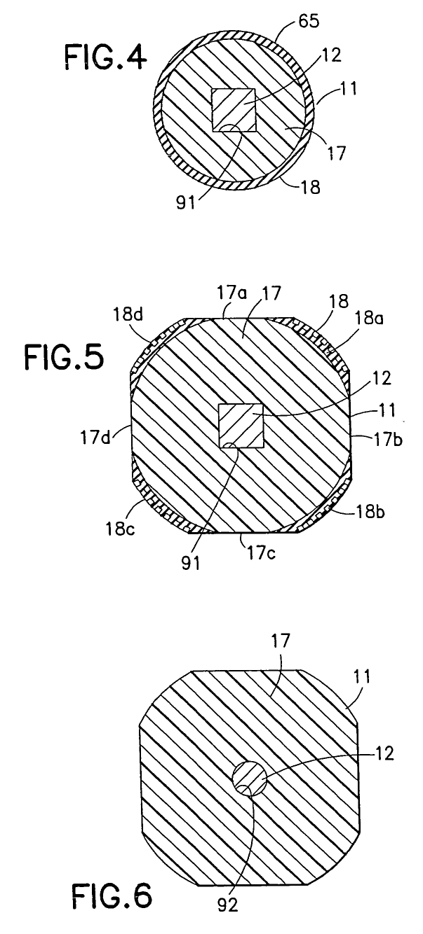

Handle 11 is formed with a distal end portion 61 juxtaposed to planar end 14. Distal end portion 61 is formed with alternate hard plastic planar surfaces 62a-62d, and elastomeric rounded surface 63a-63d which are formed and configured similarly to respective surfaces 17a-17d and 18a-18d. Elastomer cover 18 extends from grip portions 18a-18d to respective distal end portions 63a-63d and entirely covers thermoplastic core 17 at cylindrical cross-sectional recessed portion 65, as best shown in FIGS. 2, 3 and 4.

In the aforesaid manner of construction, the user grips portions 18a-18d and 17a-17d and places the thumb in recessed portion 65, or if desired, on one of the distal end surfaces 63a-63d for best desired grip and comfort.

The core may be molded of hard thermoplastic using and the cover may be molded of with elastomeric material by molding methods.

The afore-discussed handle surfaces and contours, and in conjunction with the pry bar configuration and disposition with respect to the handle, provides an ergonomic pry bar.

The invention contemplates an ergonomic handle for both pry bar and other hand tools.

In the aforesaid manner of construction, there is provided a ergonomic pry bar and handle.

While the foregoing describes certain embodiments of the invention, various modifications and changes may be made within the spirit and scope of the invention, as defined by the adjoined claims.

1. A hand tool comprising:
a handle having a distal end, a proximate end and a grip portion of generally octagonal cross-section, said handle comprising an inner thermoplastic material core and outer integrally bonded elastomeric material, a blade, said blade having a proximate end and a distal end, said blade proximate end being fixedly secured within said handle, said grip portion having an outer surface comprising eight grip surfaces, four grip surfaces comprising planar surfaces and four grip surfaces comprising curvilinear surfaces, said four planar surfaces comprising said thermoplastic material, and said four curvilinear surfaces comprising elastomeric material, and said handle distal end comprising a thumb engaging portion, said thumb engaging portion having at least two spatially disposed curvilinear receiving surfaces.

2. The hand tool of claim 1, each said thermoplastic material grip surface and each said elastomeric material grip surface being about equal.

3. The hand tool of claim 1, said elastomeric material grip surfaces being formed with a plurality of orifices.

4. The hand tool of claim 1, said thumb receiving elastomeric material surfaces being formed with a plurality of orifices.

5. The hand tool of claim 1, said thumb receiving thermoplastic material surfaces alternating with said thumb receiving elastomeric material surfaces.

6. The hand tool of claim 1, wherein each elastomeric material grip surface extends from the grip portion to the handle distal end.

7. The hand tool of claim 1, further comprising a metal impact cap fixedly disposed at the handle proximate end.

8. The hand tool of claim 1, wherein the thermoplastic material is harder than the elastomeric material.

9. The hand tool of claim 1, wherein the handle comprises a cylindrical cross-sectional recessed portion.

10. The hand tool of claim 9, wherein the handle recessed portion adjacent the handle distal end has an outer surface entirely covered by the elastomeric material.

11. The hand tool of claim 9, wherein each thermoplastic material grip surface extends from the handle proximate end to the recessed portion.

12. The hand tool of claim 1, further comprising a metal impact cap fixedly disposed at the handle distal end, and wherein the handle further comprises a through bore and the blade proximate end is fixedly disposed in the through bore distal end and is facingly disposed to the metal impact cap.

13. The hand tool of claim we, said thumb receiving surfaces comprising said thermoplastic material 14. The hand tool of claim 13, further comprising elastomeric material disposed between said spatial disposed thumb receiving surfaces.
